(19) United States
(12) Patent Application Publication
(10) Pub. No.: US 2018/0118327 A1
(43) Pub. Date: May 3, 2018

(54) AIRCRAFT WING ROTATABLE ABOUT A SPAR

(71) Applicants: Kamron Blevins, Chelan, WA (US); Michael Giles, Oceanside, CA (US)

(72) Inventors: Kamron Blevins, Chelan, WA (US); Michael Giles, Oceanside, CA (US)

(21) Appl. No.: 15/794,477

(22) Filed: Oct. 26, 2017

Related U.S. Application Data
(60) Provisional application No. 62/413,266, filed on Oct. 26, 2016.

(51) Int. Cl. B64C 3/38; B64C 3/18

(52) U.S. Cl. CPC B64C 3/385; B64C 3/187; B64C 3/185

(57) ABSTRACT

An aircraft wing that is rotatable about its spar, the spar attached to a fuselage or a central structural member of the aircraft, with the wing rotatable about the spar, and the wing rotatable to flex or tilt the wing, to change the aerodynamic properties of the wing. The wing includes ribs along the length of the wing and the spar is held stationary at a spar-anchor attachment to the central structural member, with each rib of the wing able to rotate about the spar as held by each rib.

### TECHNICAL FIELD

This invention pertains to an aircraft wing that is rotatable about its spar, and more specifically an aircraft wing with an internal spar, the spar attached to a fuselage of the aircraft or to a central structural member of the aircraft, with the wing rotatable about the spar, and the wing rotatable to flex or tilt the wing, to change the aerodynamic properties of the wing.

### BACKGROUND OF THE INVENTION

The “spar” is often included in fixed-wing aircraft as a primary structural member of the wing. The spar runs ‘spanwise’ or along the length of the wing, at approximately a right angle to the fuselage of the aircraft, depending on the sweep of the wing. The spar carries a flight load while in the air, and carries the weight of the wing while on the ground. Other structural and forming members such as ribs may be attached along the spar or to a multiple of spars within the wing. The spars and ribs are typically covered with a metal, cloth, or plastic ‘stressed skin’ under tension to also share the loads.

Early aircraft used wood spars, often carved from solid pieces or planks of spruce or ash. Spars with a box-sectional form, and laminated spars laid up in a jig and compression glued to retain the wing dihedral are also known. Wooden spars are still employed in certain light and experimental aircraft types. Disadvantages of the wooden spar include the deteriorating effects due to atmospheric conditions, both dry and wet, and biological threats such as wood-boring insect infestation and fungal attack.

Many modern aircraft utilize a metal spar construction. A common metal spar wing uses a leading edge having a ‘D-form spar-box.’ Typical metal spars in general aviation aircraft usually consist of a sheet aluminum spar web, with ‘L-shaped’ or ‘T-shaped’ spar caps welded or riveted to the top and bottom of the sheet to prevent buckling under applied loads.

Tubular metal spars have been used since 1917 as pioneered in the German ‘Junkers’ with a network of several round tubular wing spars, placed just under a corrugated aluminum wing covering, and square tubed spars in the British Spitfire′ wing, first built in 1936.

Many modern aircraft use carbon fibre and Kevlar® brand of aramid fiber in their construction, ranging in size from large airliners to small experimental type, and home-built type or light aircraft. Initially, many manufacturers employed solid fibreglass spars in designs but now use carbon fiber for high performance gliders and light aircraft. The increase in strength and reduction in weight compared to the earlier fibreglass-sparred aircraft allows for greater flight loads.

Improved spar designs are needed that allow for greater control and in-flight modifications of the aerodynamic wing surfaces. Additionally, a spar design is needed to better carry in-flight loads, while responding to flex and twist of the wing as compared to conventional spar designs, especially in light and ultra-light aircraft. The present invention addresses these problems and provides needed improvements to spar systems, and the following is a disclosure of the present invention that will be understood by reference to the following detailed description taken in conjunction with the accompanying drawings.

### BRIEF DESCRIPTION OF DRAWINGS

FIG. 1 is a perspective view of a rotatable wing, according to an embodiment of the invention;

FIG. 2 is a perspective of a rotatable wing, according to an embodiment of the invention;

FIG. 3 is cross sectional view of a rotatable wing along section line 3-3 of FIG. 2, according to an embodiment of the invention;

FIG. 4 is a perspective view of a rotatable wing, according to an embodiment of the invention;

FIG. 5 is a cross sectional view of a rotatable wing along section line 5-5 of FIG. 4, according to an embodiment of the invention; and

FIG. 6 is a perspective view of a portion of a rotatable wing, according to an embodiment of the invention.

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and may include fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

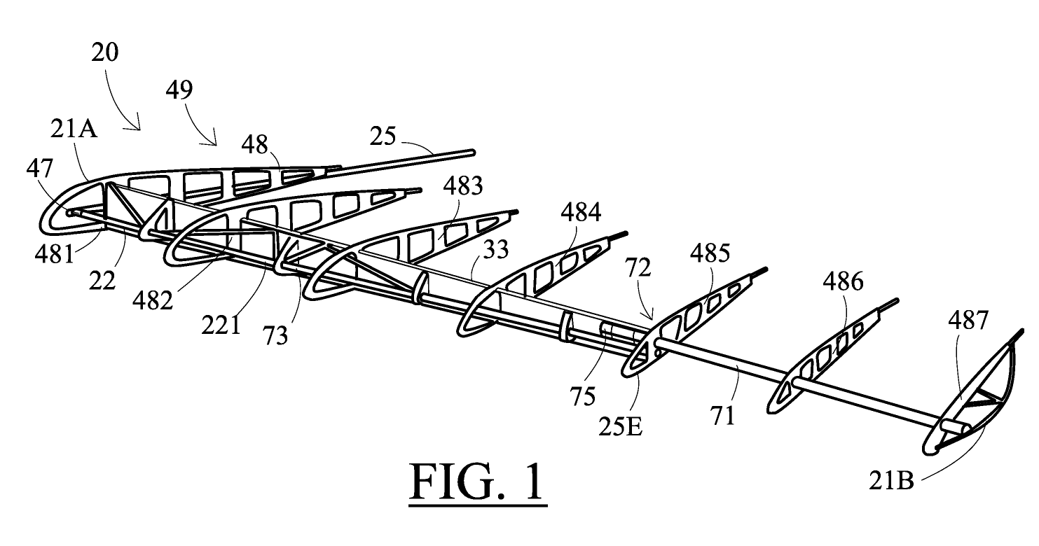

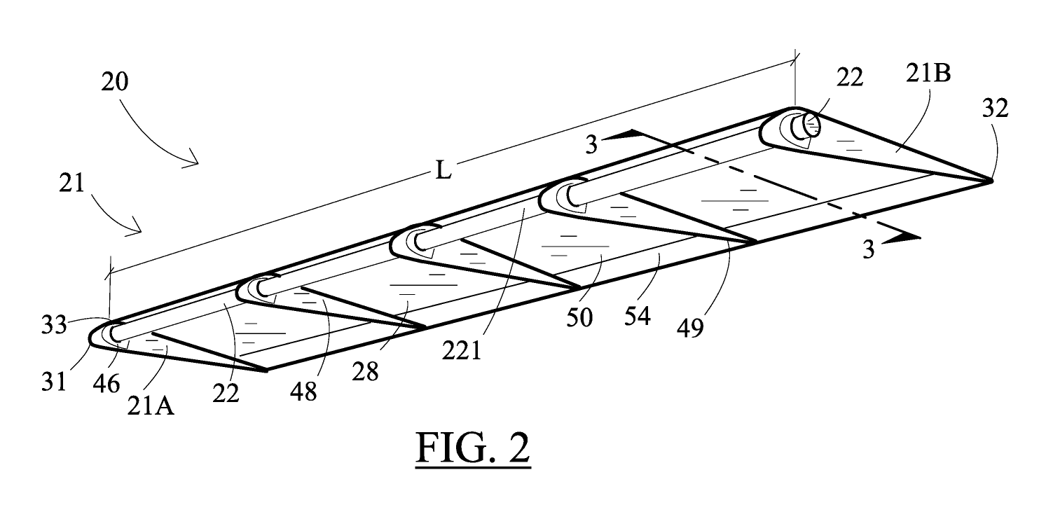

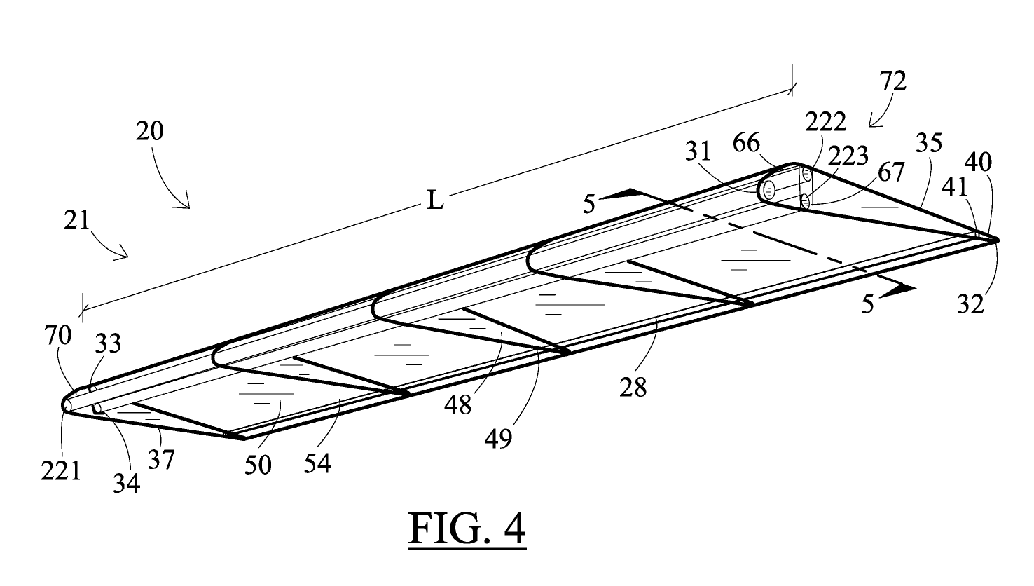

The apparatus of the present invention includes an aircraft wing that is rotatable about a spar. A wing and spar system 20, according to preferred embodiments of the invention are shown in FIGS. 1 through 6, and include a wing 21 having a spar 22 within the wing. The spar is often included in fixed-wing aircraft as a main structural member of the wing. The wing has a wing-base 21A opposite a wing-tip 21B. As shown in FIGS. 2 and 4, the wing has a length L, from wing-base to wing-tip with the spar running ‘spanwise,’ or along the length of the wing.

The spar 22 typically mounts at an approximately right angle to the main body or the fuselage of the aircraft, depending on the angle or ‘sweep’ of the wing. Preferably, as shown in FIG. 1, the spar connects to a main-bar 25, the main-bar serving as an attachment point and structural connection point to the aircraft. The main-bar may be incorporated into the structure or body of the aircraft, which may be the fuselage of an aircraft for example, or alternatively the pilot holding ‘trapeze’ of a hang glider.

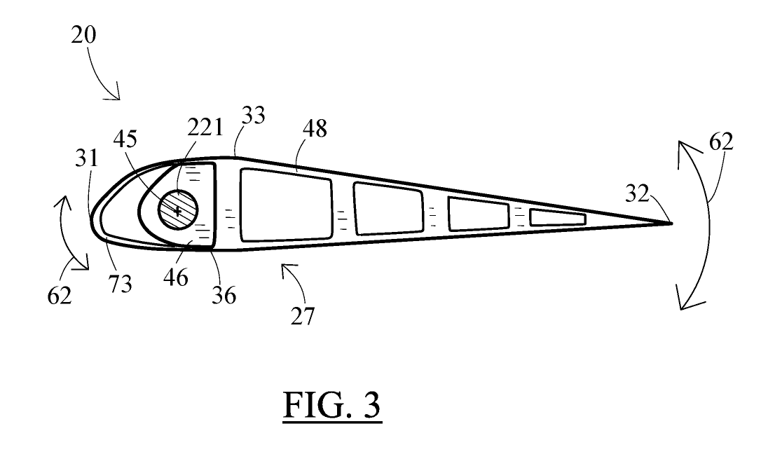

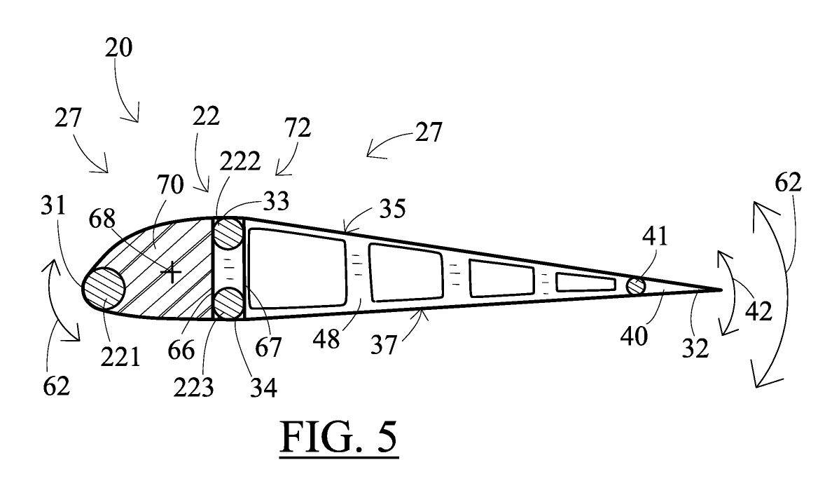

FIGS. 3 and 5 show the wing 21 in a cross-sectioned view, as having the general shape of a wing-airfoil 27. The wing-airfoil has a leading edge 31 opposite a trailing edge 32, and a highpoint 33 along a top surface 35 of the wing, with a lowpoint 36 along a bottom surface 37 of the wing. The design of the wing can include or exclude flaps. FIG. 5 shows a flap 40 at trailing-edge 32 of the wing, movable with a flap-spar 41, about a flap rotation 42. The flaps can be used for glider slope control as well for assisting in aircraft turns.

In a preferred embodiment of the wing and spar system 20, the spar 22 of the system includes at least a primary-spar 221, as shown in FIGS. 1 through 5. The primary-spar 221, can be located proximate to the leading-edge 31 of the wing airfoil 27. Most preferably, as shown in FIG. 3, a single, primary-spar is utilized, located at a wing pivot-point 45. As shown in FIGS. 2 and 3 with the single, primary-spar, each rib 48 of the wing 21 includes a spar-bracket 46, which receives and holds the primary-spar as it passes through the rib. The spar is held stationary at a spar-anchor 47 as shown in FIG. 1, and each rib rotates about the spar held within each rib's spar-bracket. The spar-anchor is shown in FIG. 1. The range that the rib can rotate about the primary-spar is a rib-rotation 62, as shown in FIGS. 3 and 5, with a smaller arc of rib rotation at the leading-edge 31 of the wing, relative to a larger arc of rib rotation at the trailing-edge 32 of the wing.

In an alternative embodiment of the wing and spar system 20, the spar 22 can include a multiple of spars. The primary-spar 221 can be augmented with secondary spars. Specifically, as shown in FIGS. 4 and 5, the primary spar can be located proximate to the leading edge 31 of the airfoil 27 of the wing 21, with a top secondary-spar 222 proximate to the highpoint 33 of the airfoil of the wing, and a bottom secondary-spar 223 proximate to at the lowpoint 34 of the airfoil of the wing. The combined structure of the primary-spar, the top secondary-spar and the bottom secondary-spar, essentially function as the single spar element 22, as described above, with the three spars for this embodiment each held stationary at their respective spar-anchor 47, to the main-bar 25 of the aircraft fuselage.

As shown in FIG. 5, the spar 22 of the wing 21 can include a front-plate 66 in front of the top secondary spar 222 and the bottom secondary-spar 223, or toward the leading-edge 31 of the wing 21, relative to the top secondary-spar and the bottom secondary-spar. Additionally, the spar can include a back-plate 67 behind the top secondary-spar and the bottom secondary-spar, or toward the trailing-edge 32 of the wing, relative to the top secondary-spar and the bottom secondary-spar.

The front-plate 66 and the back-plate 67 effectively sandwich the top secondary spar 222 and the bottom secondary spar 223, and serve to structurally ‘tie’ or connect the top secondary spar to the bottom secondary spar, so that the front-plate, the back-plate, the top secondary spar, and the bottom secondary spar function as a single unit or single ‘unitized’ spar 22. Essentially, this embodiment of the wing and spar system 20, as shown in FIGS. 4 and 5, is a uniquely modified box-spar 72. Preferably, the front-plate and the back-plate mount to the main-bar 25 proximate to the wing-base 21A, as shown in FIG. 1.

Each anchored spar 22 at a can include secondary spars 222, with each able to rotate about a wing-pivot point 68, which is a point of rotation located above or below the spar. As shown in FIG. 3, each rib 45 is able rotates about the spar held within each rib's spar-bracket 46 when a D-spar 73 is employed, or alternatively the rib is able to rotate as the box-spar 72 twists, as shown in FIGS. 4 and 5. The range that the rib can rotate about the spar is a rib-rotation 62, as shown in FIGS. 3 and 5, with the smaller arc of the rib-rotation at the leading-edge 31 of the wing, and the larger arc of the rib-rotation at the trailing-edge 32 of the wing.

Upon the rotation of the rib 48 about the spar 22, the shape of the wing-airfoil 27 of the wing 21 changes to modify the aerodynamic attributes and function of the wing. As shown in FIG. 5, for a preferred alternative of the wing and spar system 20, the primary spar 221 can remain ‘static’ or in a constant relative position, while the rib 48 pivots about the combination spar of the top secondary spar 222, the bottom secondary spar 223, the front-plate 66, and the back-plate 67, at a wing-pivot point 68. The wing-pivot point is shown in FIG. 5, as between the leading edge 31 of the wing and the front-plate 66. However, depending upon the design of the spar, and the selection of wing and spar materials and relative deflections, twists or bending of the combination spar formed with the top secondary spar, the bottom secondary spar, the front-plate, and the back-plate, for example, the wing-pivot point can be anywhere from the front leading edge, to the back-plate 66, and between the high-point 33 and the low-point 34 of the wing.

Additionally, a nose-block 70 can be included in an alternative embodiment of the wing and spar system 20. Optionally, the nose-block may be a foam material, as shown in FIG. 5. The nose-block serves to keep the shape of the wing air-foil 27 proximate to the leading-edge 31 of the wing 21, and so maintain the leading-edge of the air-foil, under any rotation of the rib 48 relative to the primary-spar 221. The foam material selected for the nose block can be any material selectable by a person skilled in light wing construction, but is most preferably a light-in-weight and resilient closed-cell foam, such as a cross-linked polyethylene foam, which also has excellent buoyancy for flotation, which is especially desirable if the wing is ditched into water.

As shown in FIGS. 1 through 6, the wing 21 includes a rib 48 that follows the profile shape of the wing-airfoil 27. Preferably, as shown in FIGS. 1, 2 and 4, a multiple of ribs are employed in the wing, with the spar 22 received through each rib. As shown in a preferred embodiment of the wing and spar system 20 of FIG. 1, a first-rib 481 is located proximate to the wing-base 21A, followed along the length L of the wing by a second-rib 482, a third-rib 483, a fourth-rib 484, a fifth-rib 485 a sixth-rib 486 and a cap-rib 487 proximate to the wing-tip 21B.

As shown in FIG. 1, each rib 48 may be attached along the spar 22 or to the multiple of spars within the wing 21. Each rib can be ‘tuned’ or engineered to rotate, twist, deflect, bend, or pivot, relative to the spar attached to that rib. The spars and ribs, along with any other structural members of the wing connect together in a structure called a wing-frame 49. Typically, the wing-frame is covered with a wing-skin 50, which is preferably a plastic ‘stressed skin,’ stretched under tension as is well-known in the field of aircraft wing fabrication, to help distribute the loads upon the wing. Alternatively, the wing-skin may be a metal, a cloth, or a fabric material. The entire envelope of wing-skin covering the wing can be referred to as a wing-sail 54, as shown transparently in FIGS. 2 and 4.

With the alternative spar 22 configurations of the wing and spar system 20, as shown in FIGS. 1 through 6, each rib 48 of the wing 21 can rotate about or is “rotatable” with the spar 22 acting as a pivot. Specifically, as each rib pivots or turns about the spar, each rib rotates with a rib-rotation 62. With the rib-rotation, the entire wing or a portion of the wing-frame 49 can rotate or twist, depending on which ribs of the wing 21 are attached to the rib being rotated by the pivoting or turning action about the spar.

As shown in FIG. 1, the spar 22 can be any combination of a round-spar 71, a box-spar 72, or a D-spar 73. With these options, the wing 21 can be fully cantilevered or cable braced, or a combination of any of these constructions. With the round spar attached to a spar-socket 75, as shown in FIG. 1, the round spar can be removed to reduce the length L of the wing for transport or storage.

Additionally, with the spar 22 of the wing 21 having the preferred D-spar 73 shape, the wing-airfoil 27, especially in proximity to the nose-block 70, can be adjusted to with the rotation of the rib 48 about the spar 22. For instance, with the primary-spar 221 as shown in FIG. 5, moved back from the leading-edge 31 of the wing, toward the trailing-edge 32 of the wing, tension on the wing-skin 50 is relieved. With the tension of the wing-skin relieved, the wing-sail 54 can slide off the wing-frame 49 for repair or service of the wing-sail or the wing-frame, or to more easily pack-up the wing for storage or transport of the wing and spar system 20.

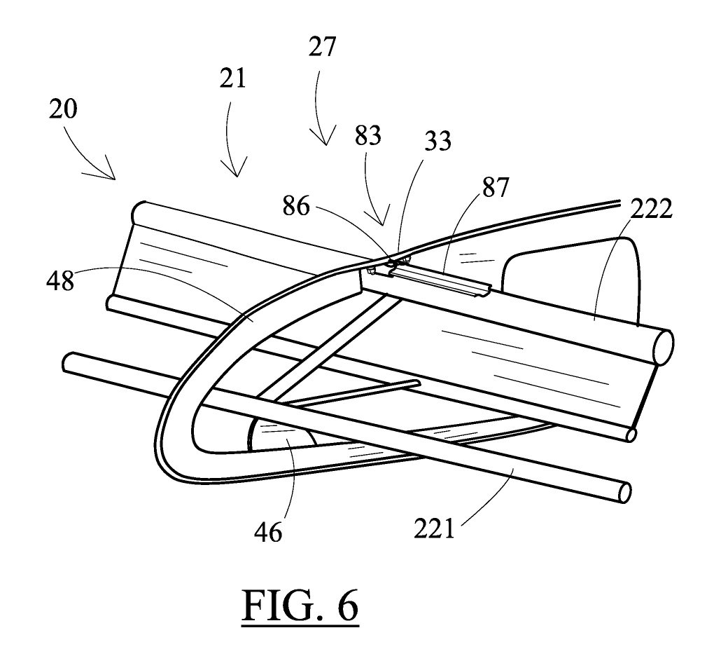

An additional alternative embodiment of the wing and spar system 20 is shown in FIG. 6, with a spar-hinge 83 located proximate to the highpoint 33 of the wing-airfoil 27. The spar-hinge connects the rib 48 to the spar 21, allowing the rib to travel along the spar. The spar-hinge includes a hinge pivot 86 and a hinge slide 87, with the hinge pivot able to move along the hinge slide. Preferably, the hinge slide is mounted on the top secondary-spar 222 at the highpoint 33 of the wing airfoil 27, and the hinge pivot is mounted on the rib, also at the highpoint of the wing airfoil. The spar-hinge provides a fine-tuning adjustment feature to the wing- and spar system, with the rib slidable on the spar-hinge to maintain tension of the wing-skin 50 and absorb impacts to the wing 21.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

Of note, the terms “substantially,” “proximate to” and “approximately” are employed herein throughout, including this detailed description and the attached claims, with the understanding that is denotes a level of exactitude or equivalence in amount or location commensurate with the skill and precision typical for the particular field of endeavor, as applicable.

The following is claimed:

1. A method of a wing and spar system comprising any steps described in the above specification and attached drawings.

2. A wing and spar system comprising any feature described in the above specification and attached drawings, either individually or in combination with any feature, in any configuration.
